(19) United States
(12) Patent Application Publication
(10) Pub. No.: US 2024/0425396 A1
(43) Pub. Date: Dec. 26, 2024

(54) METHOD AND SYSTEM FOR THE REMEDIATION OF AQUATIC FACILITIES

(71) Applicant: Truox Inc., Naples, FL (US)

(72) Inventor: Roy W. Martin, Naples, FL (US)

(21) Appl. No.: 18/817,464

(22) Filed: Aug. 28, 2024

Related U.S. Application Data
(63) Continuation-in-part of application No. 18/140,882, filed on Apr. 28, 2023.
Application No. 18/140,882 is a continuation-in-part of application No. 18/111,656, filed on Feb. 20, 2023.
Application No. 18/111,656 is a continuation-in-part of application No. 17/988,963, filed on Nov. 17, 2022.
Application No. 17/988,963 is a continuation-in-part of application No. 17/866,823, filed on Jul. 18, 2022.
Application No. 17/866,823 is a continuation-in-part of application No. 17/571,586, filed on Jan. 10, 2022, now Pat. No. 11,999,633.
Application No. 17/571,586 is a continuation-in-part of application No. 17/205,316, filed on Mar. 18, 2021, now Pat. No. 12,037,263.
(60) Provisional application No. 63/536,735, filed on Sep. 6, 2023.

(51) Int. Cl. C02F 1/76; C01B 11/02; C02F 1/66; C02F 103/42

(52) U.S. Cl. CPC C02F 1/76; C01B 11/024; C02F 1/66; C02F 2103/42

(57) ABSTRACT

A system and method for controlling multiple methods of remediation cycles for the treatment of water of an aquatic facility for immersion by humans using a process controller programmed to obtain a targeted chlorine dioxide CT Value in the water. The system controls remediation cycles having different completion time intervals and chlorine dioxide setpoints using integrated chemical feed systems.

### FIELD OF INVENTION

The invention relates to a system for controlling multiple methods of remediation cycles for the treatment of water of an aquatic facility for immersion by humans. The system controls remediation cycles having different completion time intervals and chlorine dioxide setpoints using a programmable process controller integrated with chemical feed systems and sensors for measuring water chemistry parameters. The system performs a Recovery Remediation cycle that can be completed in less than 30 minutes as well as Routine Remediation cycles comprising a daily remediation cycle while the Aquatic Facility is closed to bathers or continuous 24/7 remediation cycles while the facility is being used by bathers without concern of overfeeding the treatment.

### BACKGROUND

Free chlorine and free bromine are common sanitizers for the treatment of water at aquatic facilities. While effective at controlling bacteria counts in the water, they have limited efficacy against waterborne pathogens that are resistant to the sanitizers such as Cryptosporidium. Free halogens also form undesirable disinfection byproducts (DBPs) that foul the air, cause corrosion, irritation to skin and respiratory system.

Along with chlorine resistant microbiological organisms like Cryptosporidium, other bacterial organisms are chlorine resistant and can form bio-films within the conduit (piping) of the pools circulating system. Some non-limiting examples include: Pseudomonas aeruginosa and Enterocaccus faecium.

The Centers for Disease Control and Prevention has reported waterborne pathogens such as Cryptosporidium are accountable for nearly 80% of all Recreational Water Illness (RWI) in the United States. Combined with bacterial infections and virus, other waterborne pathogens that are resistant to chlorine and/or are embedded in a protective biofilm account for nearly 100% of all Recreational Water Illness (FIG. 1).

Chlorine dioxide is favored over many oxidizing biocides due to its biocide efficacy over a broad pH range, low use rate, biofilm penetration, membrane penetration and high selectivity in contaminated water.

Aquatic facilities experience high bather loading (number of people versus volume of water in the pool), high oxidant demand. Organics contaminants such as body oils, lotions can adsorb to the piping comprising the water intakes of the circulating system. Globular proteins in saliva, urea and various contaminants that contribute, carbon, nitrogen and sulfur impose a high demand on the disinfectants used to treat the water, the byproducts of reactions between these organic compounds and disinfectant result in disinfection byproducts (DBPs). DBPs are familiar to anyone who has experienced a heavily used indoor pool and smelled the chlorine like odor that stings the eyes and worse.

Accumulating of DBPs not only reduce water and air quality, it reduces disinfection rates which are indicated by reduced Oxidation Reduction Potential (ORP). Bacteria survive for longer periods and can become entrapped within the organic films lining the piping previously described. Entrapped bacteria thrive in the warm, nutrient rich water resulting in formation of bio-film. It is not uncommon for Aquatic Facility pools to be closed by the Department of Health for measured bacteria plate counts higher than acceptable levels. While super-chlorination removes the bacteria temporarily by killing the bacteria in the water and exposed at the surface of the biofilm, after a week of normal operations the thriving bacteria protected by the bio-film are released to contaminate the water, resulting in another failed test by the Department of health.

Cryptosporidium is a parasite having multiple membranes that make it highly resistant to chlorine. Under normal chlorine concentrations, Cryptosporidium can survive for over 1 week. Undetected, the Cryptosporidium can infect hundreds of people and no-one is to the wiser until reports of sick people visiting hospitals or doctors is reported.

In order to ensure aquatic facilities are properly protected from waterborne pathogens and address the issue of DBPs, there is a need for remediating the water as well as the entire circulating system of the Aquatic Facility to remove established microbiological organisms and the accumulated oxidant demand. Once the water and circulating system are treated using a Recovery Remediation, then the water needs to be treated using a Routine Remediation to provide a form of prophylactic.

Implementing and controlling Recovery Remediation to rid the water and circulating system of contaminants including pathogens, followed by implementation of Routine Remediation as a preventative treatment sounds straight forward and intuitive. However, the need for significant capital investment on equipment (high and low volume output feeders) or replacement of existing feeders with variable (digital) chemical feed systems integrated with a digital output controller, space for installation of new auxiliary equipment and or safety issues resulting from improper control of chemical feed resulting in the overfeed (output feed systems) while bathers are present brings to light several major hurdles before implementation would be feasible.

The chemical feed systems are typically set to their output setting to provide for Recovery Remediation. Typically, this will be at or near their maximum output setting for the feed systems. As such, the tendency to overfeed chemical when controlling Routine Remediation cycles is high.

Problems also arise due to the fact that the control parameters needed to achieve the Recovery Remediation cycles and Routine Remediations cycles are starkly different.

Recovery Remediation cycles have a short completion time interval requiring application of higher concentrations of chlorine dioxide in a short period of time to achieve the target Ct Value within the completion time interval. To the contrary, Routine Remediation applies low concentrations to achieve completion time intervals often many times higher. The chemical feed systems must be controlled to compensate for these variations without compromising the remediation cycle or compromising safety of the bathers and facility staff from overfeeding. Sizing a chemical feed system capable of delivering high concentrations of treatment to achieve the remediation Ct Value within the short completion time interval is not suited for controlling low concentrations that are safe for contact with bathers while conducting Continuous 24/7 Remediation cycles.

U.S. Pat. Nos. 7,922,933, 7,927,509, and 7,976,725 which are herein incorporated by reference in their entirety, disclose a cyclic process for the in-situ generation of chlorine dioxide. The cyclic process utilizes bromide ions that are activated by an oxidant to produce free bromine. The free bromine oxidizes chlorite ions producing chlorine dioxide. Chlorine dioxide inactivates microbiological organisms (i.e. Cryptosporidium). During this process the free bromine and at least some portion of the chlorine dioxide are reduced back to bromide ions and chlorite ions respectively which are recycled back to free bromine and chlorine dioxide utilizing the cyclic process.

My earlier U.S. Published Patent Application Nos. 2019-0300398 and 2020-0346948, which are herein incorporated by reference in their entirety, disclose methods for in-situ generation and stabilization of chlorine dioxide in the water of an aquatic facility using UV activation of chlorite ions.

My earlier U.S. Published Patent Application Nos. 2021-0323838 and 2022-0127164, which are herein incorporated by reference in their entirety, disclose methods for in-situ generation and stabilization of chlorine dioxide in the water of an aquatic facility.

Co-pending application Ser. Nos. 17/571,586, 17/988,963, 17/866,823, 17/205,316, 18/111,656 and 18/140,882 which are herein incorporated by reference in their entirety, disclose methods and a system for controlling remediation cycles, and methods for the in-situ generation of chlorine dioxide.

My earlier U.S. Published Patent Application No. 2021-0323838 and 2022-0127164 use existing process controllers to control the chlorine dioxide concentration in the swimming pool water. The limitations provided by existing swimming pool process controllers are exemplified in the control examples provided. A chemical feed system designed to support Recovery Remediation will overfeed chlorine dioxide using time-based proportional control or ON/OFF control. Therefore, a secondary chemical feed system is required, or the chemical feed system output must be manually adjusted to reduce the feed rate of chlorine dioxide. In the reverse case where the chemical feed systems are designed to support Routine Remediation, they will not provide the chlorine dioxide feed rate to support the Recovery Remediation and complete the remediation within the completion time interval. Furthermore, reducing the chemical feed rate manually can impair the performance of accelerated in-situ generation of chlorine dioxide since the localized high concentrations of reactant chemicals is compromised, with some chemicals being applied while others are not as a result of having different speed and stroke setting on the chemical feed systems (i.e. pumps).

U.S. Pat. No. 4,224,154 discloses a swimming pool chemical control system. The invention discloses a method of time-based proportional control. Referring to column 4, lines 9-27, the controller employs various timers with one short duration timer controlling the ON time, and a second longer duration timer controlling the OFF time. The duration of the ON and OFF time is predetermined.

Another variation of timed-based proportional control is exemplified by controllers sold by BECS Technologies, Inc. located in St. Louis, MO.

The BECS TBP control applies a SPAN that consist of a numeric value representing the deviation (decrease) from the Setpoint at which the process controller activates the chemical feed system(s) ON for 100% of the time. When the deviation is less than the SPAN value, the ON-Time is proportional to the deviation and is calculated using equation: ON-Time=(Deviation/SPAN)×60 seconds.

Existing time-based proportional control is suited for control of singular treatment having a predetermined setpoint. Furthermore, chemical feed systems are sized and/or manually adjusted to provide a chemical output that applies the treatment at a rate as to prevent excessive overfeed. For example, a chemical pump output may be adjusted to 40% of its maximum output so that the speed and/or the stroke (volume) of each pulsed output from the pump is reduced. Combining these existing (standard) methods of time-based proportional control with sized chemical feed systems provides good control of a singular treatment having a single setpoint.

There is a need for a system capable of controlling multiple methods of remediation cycles having different completion time intervals, preferably using the same integrated chemical systems. The invention provides a system for controlling multiple methods of remediation cycles comprising a “Recovery Remediation” and a “Routine Remediation”.

### SUMMARY OF THE INVENTION

The invention comprises a system for controlling multiple methods of remediation cycles having different completion time intervals and ClO₂ Setpoints. A process controller is integrated with sensors for measuring critical water chemistry parameters and chemical feed systems for applying the chemicals. The process controller is programmed to apply and control the chlorine dioxide at different rates to achieve higher concentrations of chlorine dioxide in the case of a Recovery Remediation cycle and lower concentrations of chlorine dioxide in the case of Routine Remediation cycles using Remedial TBP control. The ability to safely control a Routine Remediation cycle using continuous 24/7 treatment while bathers are present, then quickly implement a Recovery Remediation cycle that remediates the water in less than 30 minutes using conventional integrated system provides owners, management and operators of Aquatic Facilities unprecedented capability, performance and water quality. Furthermore, since the majority of Aquatic Facilities already implement process control and chemical feed systems, an existing system can be upgraded with a kit making implementation low cost and readily available to the entire industry without expensive capital investment. Addition of a chlorine dioxide sensor, a chemical feeder for applying sodium chlorite and inserting a chip programmed to control Multiple Methods of Remediation cycles into an existing process controller can transform a traditional process controller for controlling pH and disinfectant into a system capable of controlling multiple methods of remediation cycles, thereby having the ability to irradicate Recreational Water illness (RWI).

Objectives of the invention include mitigating nearly 100% of all Recreational Water Illness (RWI) as described by the Centers for Disease Control and Prevention. Furthermore, the invention provides for a system that can be retrofit to existing process control and chemical feed systems to upgrade from a traditional sanitizer and pH control system to a system for controlling multiple methods of remediation cycles. Furthermore, implementing one or more of several methods for the in-situ generation of chlorine dioxide disclosed in the existing and co-pending prior art eliminates the need for capital investment in a chlorine dioxide generator.

The objectives of the invention can be obtained by an embodiment which comprises a system for controlling multiple methods of remediation cycles for the treatment of water of an aquatic facility for immersion by humans, the system comprising:
a process controller in communication with sensors and chemical feed systems for the measurement and control of pH, chlorine dioxide and a free halogen sanitizer, the chemical feed system(s) are located downstream of the sensors with both sensors and chemical feed systems in fluid contact with the water of the Aquatic Facility, resulting in an integrated system;
the process controller is programmed to control Recovery Remediation cycles and Routine Remediation cycles, each having a different completion time interval and ClO₂ Setpoint and where the completion of the Remediation cycle is determined by achieving a targeted chlorine dioxide CT Value;
the process controller is programmed to control the chlorine dioxide feed system(s) using remedial time-based proportional control (remedial TBP), wherein remedial TBP determines the chlorine dioxide feed system(s) ON-Time following the formula:

$$[ \frac{{ClO}_{2} Setpoint ( ppm ) - Measured {ClO}_{2} ( ppm )}{{ClO}_{2} Dynamic \times 10 \times Dynamic compensation} ] \times Time Segment = ON - Time$$

### Where,

“Time Segment” is a segment of time reported in seconds or minutes (i.e. 60 seconds),
“ClO₂ Setpoint (ppm)” is the ClO₂ Setpoint for the selected remediation cycle,
“Measured ClO₂ (ppm)” is the ClO₂ value measured by the ClO₂ sensor,
“ClO₂ Dynamic” is the concentration of ClO₂ being applied to the water and is based on the total volume of water being treated per unit time (ClO₂ ppm/minute),
“Dynamic Compensation” (DC) is a unique value for each aquatic facility and compensates effects of lag-time on measurement of the chlorine dioxide concentration in the water by the chlorine dioxide sensor after chlorine dioxide has been fed to the water from the chlorine dioxide feed system, and the DC has a value ranging from 0.2 to 2.0.

The Dynamic Compensation preferably has a default value of 1.0.

The Dynamic Compensation can be optimized following the formula:

$$DC ( Optimized Value ) = Theoretical {ClO}_{2} ( ppm ) increase / Deviation from Setpoint ( ppm ) \times Y$$

### Where,

$$“ Theoretical {ClO}_{2} ( ppm ) increase ” = ( ON - Time / Time segment ) \times lag - time \times {ClO}_{2} Dynamic$$

$$“ Deviation from Setpoint ” = {ClO}_{2} Setpoint - Measured {ClO}_{2}$$

“Y” is the “Lag-time Adjustment” having a value ranging from 1.01 to 2.5, preferably 1.05 to 2.0, and most preferred 1.1 to 1.5.

The “Lag-time Adjustment” is a percentage of variance allowed by the DC (Optimized Value). A “Y” value of 1.3 to 1.5 provides a potential 30-50% increase in ClO₂ concentration over the ClO₂ Setpoint. A “Y” value of approximately 1.3 to 1.5 is a practical setting for the very purpose the DC Value is implemented, lag-time. While the sensor is providing a measurement and determining the subsequent deviation from the setpoint, the chlorine dioxide concentration continues to decline over the period of lag-time. Assigning a feed rate to slightly overshoot the Deviation from setpoint will result in a measured value very close to the ClO₂ Setpoint by the time the ClO₂ dissipates throughout the water to reach equilibrium.

The Dynamic Compensation can be automatically adjusted by the process controller.

The Dynamic Compensation can be manually adjusted.

The Recovery Remediation cycle preferably has a completion time interval ranging between 0.25 to 3.5 hours.

The Recovery Remediation cycle preferably has a ClO₂ Setpoint ranging from 2 to 20 ppm.

The Routine Remediation cycle preferably has a completion time interval ranging between 3.5 to 24 hours.

The Routine Remediation cycle preferably has a ClO₂ Setpoint ranging from 0.2 to 1.0 ppm.

The Recovery Remediation can further comprise a Biofilm Remediation cycle and a Shock Remediation cycle.

The process controller can be programmed to provide a Recovery Remediation cycle comprising the steps:
the process controller initiating the Recovery Remediation cycle;
measuring the chlorine dioxide concentration;
calculating a chlorine dioxide Ct value;
sustaining the concentration of chlorine dioxide until the targeted chlorine dioxide Ct value is achieved;
and the process controller recording the time when the targeted chlorine dioxide Ct value is achieved and terminating the remediation cycle.

The Routine Remediation can further comprise a Daily Remediation cycle and/or Continuous 24/7 Remediation cycles.

The process controller can be programmed to provide a Daily Remediation cycle comprising the steps:
the process controller initiating the Daily Remediation cycle;
measuring the chlorine dioxide concentration;
calculating a chlorine dioxide Ct value;
sustaining the concentration of chlorine dioxide until the targeted chlorine dioxide Ct value is achieved;
and the process controller recording the time when the targeted chlorine dioxide Ct value is achieved and terminating the remediation cycle.

The process controller can be programmed to provide a Continuous 24/7 Remediation cycles comprising the steps:
a) the process controller initiating the Continuous 24/7 Remediation cycles;
b) measuring the chlorine dioxide concentration;
c) calculating a chlorine dioxide Ct value;
d) sustaining the concentration of chlorine dioxide until the targeted chlorine dioxide Ct value is achieved;
and
e) the process controller recording the time when the targeted chlorine dioxide Ct value is achieved, terminating the remediation cycle, resetting the chlorine dioxide Ct value to zero, and then repeating the steps a) through e).

The process controller can be programmed to set the chlorine dioxide chemical feed system(s) to their maximum output.

The process controller can be programmed for controlling the sanitizer and pH control feed systems using time-based proportional control.

The objectives of the invention can be obtained by another embodiment which comprises a method for controlling multiple methods of remediation cycles for the treatment of water of an aquatic facility for immersion by humans, the method comprising:
providing an integrated system comprising:
a chlorine dioxide sensor in fluid communication with the water;
a chlorine dioxide feed system in fluid communication with the water, the chlorine dioxide feed system is downstream of the chlorine dioxide sensor, and chlorine dioxide is fed to the water during ON-Time;
a process controller in communication with the chlorine dioxide sensor and the chlorine dioxide feed system for measurement and control of chlorine dioxide in the water;
the process controller is programmed to control recovery remediation cycles and routine remediation cycles of the water, the recover remediation cycles having a different completion time interval and ClO₂ Setpoint than the routine remediation cycles, and completion of the recovery remediation cycles and the routine remediation cycles is determined by achieving a targeted chlorine dioxide CT Value;
the process controller is programmed to control the chlorine dioxide feed system using remedial time-based proportional control (remedial TBP), wherein the remedial TBP determines the chlorine dioxide feed system ON-Time following the formula:

$$[ \frac{{ClO}_{2} Setpoint ( ppm ) - Measured {ClO}_{2} ( ppm )}{{ClO}_{2} Dynamic \times 10 \times Dynamic Compensation} ] \times Time Segment = ON - Time$$

where,
Time Segment is a segment of time reported in seconds or minutes;
ClO₂ Setpoint (ppm) is the ClO₂ Setpoint for the selected routine remediation cycle or recovery remediation cycle;
Measured ClO₂ (ppm) is the ClO₂ value measured by a chlorine dioxide sensor;
ClO₂ Dynamic is a concentration of ClO₂ being fed to the water from the chlorine dioxide feed system and is based on a total volume of water being treated per unit time (ClO₂ ppm/minute); and
Dynamic Compensation (DC) is a unique value for each aquatic facility and compensates effects of lag-time on measurement of the chlorine dioxide concentration in the water by the chlorine dioxide sensor after chlorine dioxide has been fed to the water from the chlorine dioxide feed system, and the DC has a value ranging from 0.2 to 2.0;
wherein,
the process controller initiates a remediation cycle;
the process controller feeding the chlorine dioxide from the chlorine dioxide feed system to the water during the On-Time;
measuring a chlorine dioxide concentration in the water using the chlorine dioxide sensor;
and
the process controller stopping feeding of the chlorine dioxide from the chlorine dioxide feed system to the water when the targeted chlorine dioxide CT Value of the water is obtained.

When chlorine dioxide is applied using accelerated in-situ generation of chlorine dioxide, the chemical feed systems used to generate the chlorine dioxide are preferably controlled using remedial time-based proportional control. Furthermore, the relays used to actuate the chemical feed systems are preferably activated the same time by the process controller so the chemicals are applied to achieve localized high concentrations within the conduit.

When remediation cycles are not being applied, the pH and sanitizer feed systems can be controlled by the process controller using time-based proportional control, on/off control, or any other suitable means of controlling the chemical feed.

The programmable process controller calculates, records, and stores the chlorine dioxide Ct value of the water. The process controller can also display the chlorine dioxide Ct value. The process controller can be programmed to forecast the time to achieve the targeted chlorine dioxide Ct value of the water. The calculated chlorine dioxide Ct value can be based on the rolling average of the chlorine dioxide concentration. The chlorine dioxide Ct value is calculated at any desired interval, for example every 0.1 to 60 minutes. The chlorine dioxide Ct value can be calculated by:

$$Chlorine dioxide Ct value = [ ( \sum {X}_{n} ) \div n ] \times T$$

Where:
“Xₙ” is the chlorine dioxide concentration in mg/l (or ppm) recorded at a point in time since beginning the remediation cycle;
“n” is the number of chlorine dioxide values recorded over a period of time since beginning the remediation cycle; and
“T” is the period of time (minutes) that has lapsed since beginning the remediation cycle.

Another suitable option for calculating the chlorine dioxide Ct value is by summation of sampling time intervals. The chlorine dioxide Ct value is calculated at any desired interval, for example every 0.1 to 60 minutes. The chlorine dioxide Ct value can be calculated by:

$$Chlorine dioxide Ct value = \sum [ ( \sum {X}_{n} \div n ) \times T ]$$

Where:
“Xₙ” is the chlorine dioxide concentration in mg/l (or ppm) recorded at a point in time over the sampling period;
“n” is the number of chlorine dioxide values recorded over the sampling period; and
“T” is the period of time (minutes) that has lapsed over the sampling period.

Any suitable sanitizer sensor can be utilized, such as an ORP sensor or an amperometric sensor for measuring free and/or total chlorine. The system preferably utilizes both ORP and amperometric sensor for measuring the relative concentration of sanitizer.

Chlorine dioxide can be applied using any suitable means of generating and delivering chlorine dioxide. For example, chlorine dioxide can be generated in-situ using accelerated in-situ generation, cyclic process, UV activation of chlorite or their combinations. Methods for in-situ generations using these methods have been disclosed in the referenced prior art.

For outdoor aquatic facilities UV activation of chlorite ions supports chlorine dioxide generation and depletes the chlorite concentration thereby preventing accumulation of an undesirable byproduct in the water.

For indoor aquatic facilities, the preferred method in inhibiting accumulation of chlorite ions in the water is by employing the cyclic process wherein hypobromous acid activates chlorite to produce chlorine dioxide in-situ. The hypobromous acid is reduced to bromide ions, which are then oxidized back to hypobromous acid by further addition of free chlorine.

Chlorine dioxide can also be applied using ex-situ generation using a chlorine dioxide generator. One such example of a suitable chlorine dioxide generator is disclosed in U.S. Pat. No. 9,656,891.

Dynamic Compensation is a numeric value that compensates for the lag-time which is the lapsed time from when the chemical is applied to the water to the time the chemical influences the sensor. The Dynamic Compensation can be preset to a default value, preferably 1.0, then manually or automatically adjusted by the process controller to optimize the chemical feed for the particular aquatic facility.

The Dynamic Compensation is optimized to tighten control of the chlorine dioxide concentration by trimming the chemical feed systems using the formula:

$$DC ( Optimized Value ) = Theoretical {ClO}_{2} ( ppm ) increase / Deviation from Setpoint ( ppm ) \times Y$$

### Where,

$$“ Theoretical {ClO}_{2} ( ppm ) increase ” = ( ON - Time / Time segment ) \times lag - time \times {ClO}_{2}$$

### Dynamic

$$“ Deviation from Setpoint ” = {ClO}_{2} Setpoint - Measured {ClO}_{2}$$

“Y” is the “Lag-time Adjustment” having a value ranging from 1.01 to 2.0, preferably 1.05 to 1.8, and most preferred 1.1 to 1.5.

The Dynamic Compensation can be manually or automatically adjusted to improve the control performance and maintain chemical concentrations close to the setpoint to compensate for the aquatic facility's dynamics (lag-time).

### BRIEF DESCRIPTION OF THE DRAWINGS

FIG. 1 illustrates the Etiology of microbial infections from treated swimming pools provided by the Centers for Disease Control and Prevention.

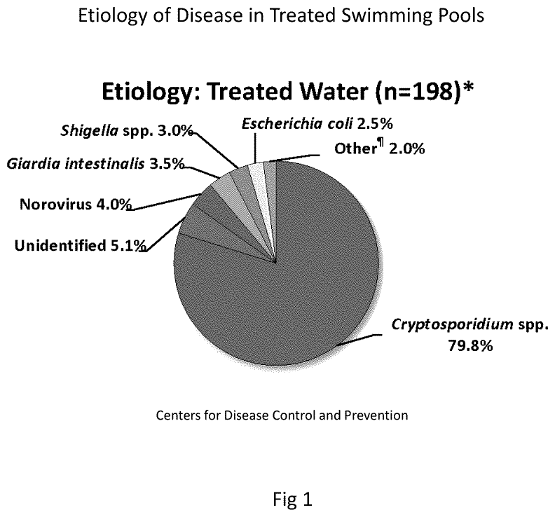

FIG. 2 illustrates the in-situ generation of chlorine dioxide using the cyclic process.

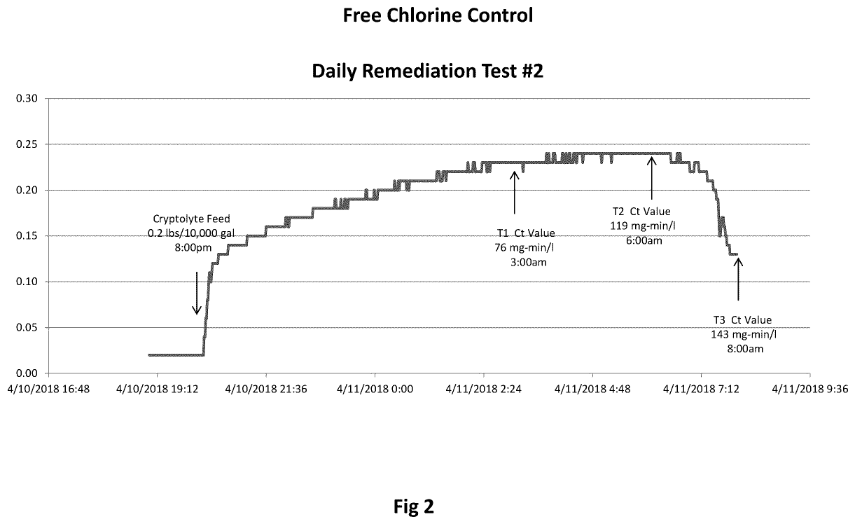

FIG. 3 is the events logs supporting FIG. 2 showing the application of Cryptolyte® (sodium chlorite solution) and the effects on ORP.

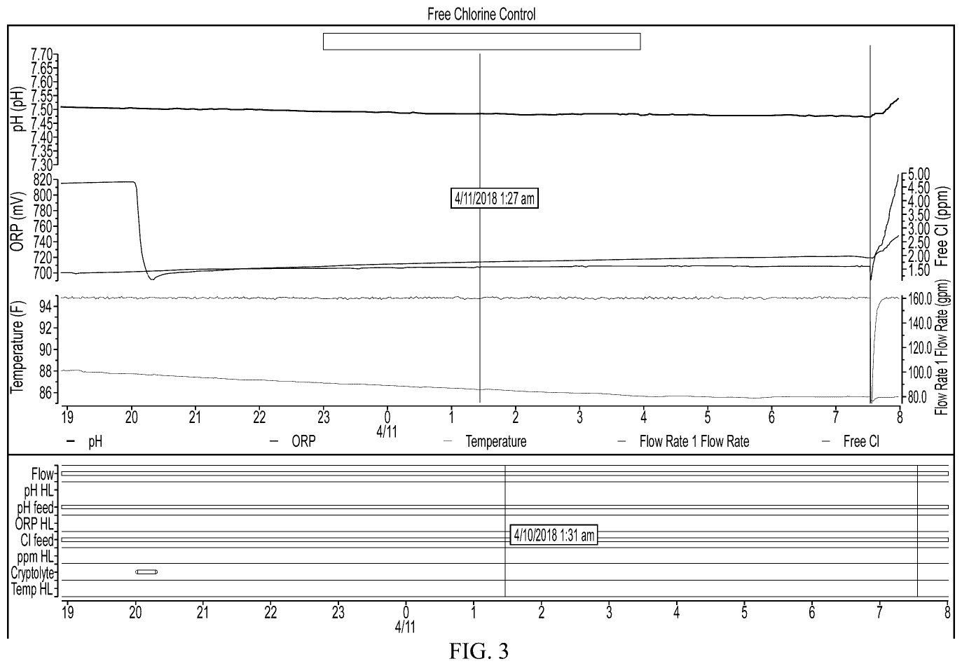

FIG. 4 illustrates a cyclic process for the in-situ generation of chlorine dioxide disclosed in the referenced prior art.

FIG. 5 illustrates the configuration of the integrated process control system as it relates to the circulating system of the aquatic facility. Conduit (33) in which accelerated in-situ generation of chlorine dioxide takes place in an integral part of the pools circulating system, while the pool (4) is where the majority of the in-situ generation of chlorine dioxide will occur as a result of UV activation of chlorite and/or the cyclic process.

FIG. 6 and FIG. 7 illustrate the rapid increase in in-situ generated chlorine dioxide as a result of the accelerated in-situ generation of chlorine dioxide.

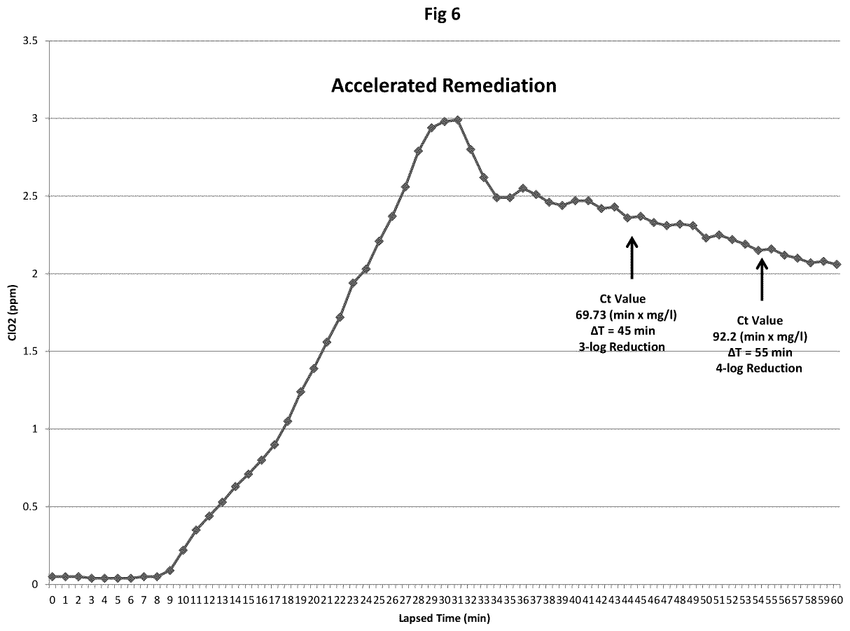

FIG. 7 further illustrates the application of neutralizer to remove residual treatment after completing the remediation.

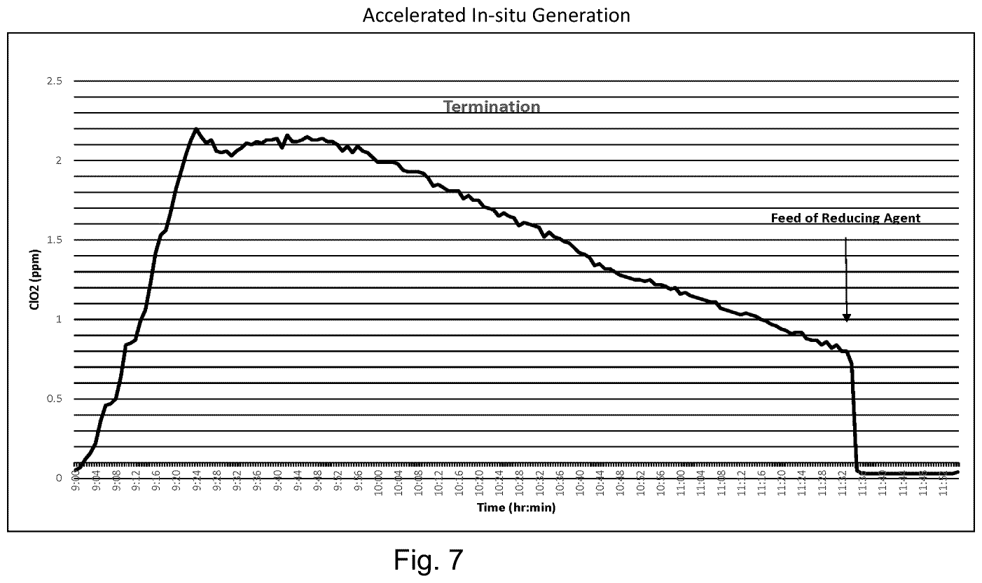

FIG. 8 illustrates a non-limiting example of an integrated system for controlling multiple remediation cycles using Accelerated In-situ generation of chlorine dioxide like that disclosed in co-pending application Ser. No. 18/140,882.

### DETAILED DESCRIPTION OF THE INVENTION

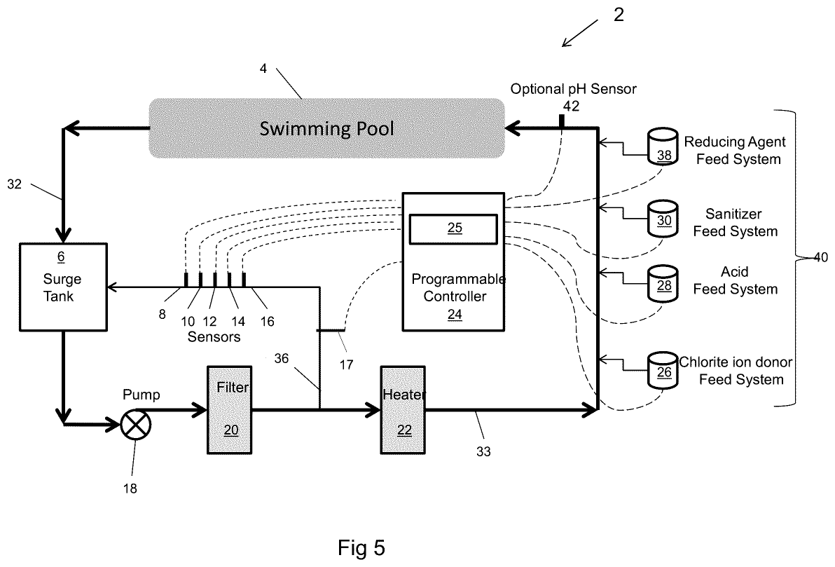

The invention will be explained with reference to attached non-limiting FIGS. FIG. 5 illustrates an exemplary integrated process control system 2 for controlling multiple Remediation cycles for the treatment of the water 4 and circulating system 32, 6, 18, 20, 22, and 33 in an aquatic facility. In an aquatic facility, the water 4, such as in a swimming pool, typically flows out of the pool through exit conduit 32 to a surge tank 6, water pump 18, filter 20, heater 22, and then back into the pool via return conduit 33. A chemical feed system 40 is connected to the water 2, such as through the conduit 33. Examples of chemical feed systems 40 include a sanitizer feed system 30 for supplying sanitizer such as free halogen to the water 4, an acid feed system 28 for supplying chemicals to adjust or control the pH of the water 4, a chlorite donor feed system 26 for supplying chlorite ions to the water 4, and an optional reducing agent feed system 38 for supplying a reducing agent or other chemicals to the water 4.

A first sanitizer sensor 8 and a second sanitizer sensor 10 can be used to measure the relative concentration of sanitizer in the water 4. For example, the first sanitizer sensor 8 can be an ORP senor and the second sanitizer sensor 10 can be amperometric type sensor. A pH sensor 12 can be used to measure the pH of the water 4. A chlorine dioxide sensor 14 can be used to measure the concentration of chlorine dioxide in the water 4. A temperature sensor 16 can be used to measure the temperature of the water 4. A flow sensor 17 can be used to measure or indicate the water flow through the conduit 36 from which the sensors 8, 10, 12, 14, 16 and 17 are connected to sample the water 4.

A process controller 24 is used to control the water treatment of system 4. The chlorite donor feed system 26 (interchangeable with a chlorine dioxide generator), the acid feed system 28 and the sanitizer feed system 30 are connected to and controlled by the process controller 24. The sensors 8, 10, 12, 14, 16 and 17 are connected to and provide measurements to the process controller 24.

The invention comprises a system for controlling multiple methods of remediation cycles having different completion time intervals. The process controller is integrated with sensors for measuring critical water chemistry parameters and chemical feed systems for applying the chemicals. The process controller is programmed to apply and control the chlorine dioxide at different rates to achieve higher concentrations of chlorine dioxide in the case of a Recovery Remediation cycle and lower concentrations of chlorine dioxide in the case of Routine Remediation cycles. The ability to safely control a Routine Remediation cycle using continuous 24/7 treatment while bathers are present, then quickly implement a Recovery Remediation cycle that remediates the water in less than 30 minutes using the same integrated system provides owners, management and operators of Aquatic Facilities unprecedented capability, performance and water quality. Furthermore, since the majority of Aquatic Facilities already implement process control and chemical feed systems, an existing system can be upgraded with a kit making implementation low cost and readily available to the entire industry without expensive capital investment. Addition of a chlorine dioxide sensor, a chemical feeder for applying sodium chlorite (or a chlorine dioxide generator for ex-situ generation) and inserting a chip programmed to control Multiple Remediation cycles into the existing process controller is all that is needed to transform a traditional controller for controlling pH and disinfectant into a system capable of controlling multiple remediation cycles, thereby having the ability to irradicate Recreational Water illness (RWI).

The Florida Department of Health pH range for the water 4 of an aquatic facility is from 7.2 to 7.8 with the recommended range being 7.4 to 7.6. The programmable process controller 24 automatically monitors and controls the pH to operate within these ranges using the pH sensor 12 and acid feed system 28. Due to the significant lag time between the time of feeding pH related chemicals (i.e. acid) from the acid feed system 28 and the time to return a representative sample for the pH sensor 12 to measure, control logic is used to minimize the potential for overfeed of the chemical. Examples of control logic is on/off control and time-based proportioned control.

The Florida Department of Health Sanitizer range for chlorine (reported as Cl₂) sanitizer is from 1-10 ppm in pools and 2-10 ppm in spas. For bromine (reported as Br₂) the range is 1.5-10 ppm in pools and 3-10 ppm in spas.

During Routine Remediation comprising Daily Remediation, the water is treated with mixed oxidants in the evening when the swimming pool is closed. When the swimming pool is opened to bathers there may be some residual chlorine dioxide from the evening remediation, but during the remainder of the day the water is treated with only free chlorine and/or free bromine.

During Routine Remediation comprising Continuous 24/7 Remediation, the water is treated with mixed oxidants comprising chlorine dioxide and free chlorine and/or free bromine. The combination of mixed oxidants provides allows for operating with the free halogen concentration at the lower range, near 1.0 ppm as Cl₂ as the chlorine dioxide provides additional biocidal efficacy as a powerful disinfectant.

The process controller 24 tracks the chlorine dioxide concentration measured by the chlorine dioxide sensor 14 during the Continuous 24/7 Remediation and calculates the rolling average (also referred to as a “moving average”). The rolling average is multiplied by the time that has lapsed measured in minutes to update the chlorine dioxide Ct value in real-time. The rolling average can be updated over any desired period of lapsed time. One preferred period of lapsed time ranges from 0.1 to 60 minutes, more preferred 0.2 to 30 minutes, and most preferred 0.5 to 10 minutes. The ability to frequently update the real-time chlorine dioxide Ct value allows the process controller to forecast the trend and project when the targeted chlorine dioxide Ct value will be reached. Once the targeted chlorine dioxide Ct value is achieved, the process controller records the value and the time it was achieved. The process controller then resets the chlorine dioxide Ct value to zero (0), then repeats the process.

The process controller 24 can be configured to calculate, record, and store the chlorine dioxide Ct value. Optionally the controller 24 can display the chlorine dioxide Ct value on the display 25 and callout to a technician in the event of a successful or failed remediation cycle. Once the chlorine dioxide Ct value has been achieved, the process controller records the chlorine dioxide Ct value and the time it was achieved, resets the chlorine dioxide Ct value to zero (0), then repeats the process.

When electrolysis of chloride salts is used to generate free halogen (sanitizer), additional acid 28 may not be required. Electrolysis produces chlorine gas (Cl₂) which hydrolyses to form hypochlorous acid (HOCl) and hydrochloric acid (HCl).

When applying chlorine dioxide using in-situ generation, the simultaneous chemical feed of free halogen and acid from an electrolysis device (chlorine generator) and chlorite donor achieve localized high concentrations in the conduit. Fluid dynamics within the conduit combine the high concentrations of chemicals to induce a high rate of reaction resulting in elevated concentrations of chlorine dioxide in the conduit without the feed of additional acid from the acid feed system 28. The optimization of acid feed may be further improved by implementing a pH sensor into the conduit 42 that is in fluid contact with the process controller that can automatically adjust the acid feed 28.

When applying chlorine dioxide using ex-situ generation from a chlorine dioxide generator, the chlorite donor 26 is the chlorine dioxide applied from the chlorine dioxide generator.

A reducing feed system 38 interfaced with the process controller 24 and in fluid contact with the water 4 of the aquatic facility provides the ability to feed a reducing agent exemplified by sodium thiosulfate in order to neutralize any excess sanitizer after a Recovery Remediation cycle.

Once the target chlorine dioxide Ct value is achieved the remediation cycle can be terminated. The process controller can be programmed to automatically feed a reducing agent to the water based on the excess residual chlorine dioxide, oxidizer and/or sanitizer in the water. The approximate concentrations of residuals can be determined by either direct measurements utilizing amperometric and chlorine dioxide sensors and/or by calculation.

Calculated residuals can be determined by knowing the relative amounts of chlorite ions and oxidizer/sanitizer applied to the swimming pool. Knowing the relative amounts of each said chemical allows for approximating the amount of reducing agent needed to neutralize the excess residuals and accelerate the process of achieving compliance with the Dept of Health regulations to reopen the pool for use.

The remediation cycle is based on achieving a chlorine dioxide CT Value reported as mg/l×min.

Recovery Remediation comprises a Biofilm Remediation performed at the startup to remove the existing accumulated microbial (biofilm and/or Cryptosporidium) and chemical contaminants (e.g. enzymes, DBPs), and Shock Remediation performed after a known or suspected fecal release that is suspected of Cryptosporidium.

For Bio-film Remediation within the circulating system and achieving ≥6-log reduction of the entrapped bacteria, the chlorine dioxide CT Value ranges between 300 to 3000 (mg/l×min), more preferred 400 to 2500 (mg/l×min) and most preferred 500 to 2000 (mg/l/min).

For Shock Remediation Cryptosporidium in the water of an Aquatic Facility, the chlorine dioxide CT Value ranges between 80 to 400 (mg/l×min), more preferred 90 to 350 (mg/l×min) and most preferred 100 to 300 (mg/l/min).

Remediation of Cryptosporidium after a known or suspected fecal release and for bio-film remove from the circulating system is best achieved by applying a high concentrations of chlorine dioxide in the form of a shock treatment. For a Recovery Remediation cycle the chlorine dioxide setpoint ranges from 2 to 20 ppm, more preferred 3 to 15 ppm and most preferred 4 to 10 ppm.

Contaminants are routinely being added to the water of the Aquatic Facility while bathers are present. The mechanisms that lead to suppression of ORP and subsequent formation of biofilms are ongoing. Furthermore, the potential for an undetected release of Cryptosporidium from an infected person is always present as documented infections occur in treated recreational water every year. To minimize the potential for the onset and accumulation of biofilm and/or infections resulting from an undetected release of Cryptosporidium into the water, Routine Remediation cycles are performed.

Routine Remediation cycles comprise either Daily Remediation cycles or Continuous 24/7 Remediation cycles are employed as a form of prophylactic.

Routine Remediation cycles require low concentrations of chlorine dioxide. For Daily Remediation cycles or Continuous 24/7 Remediation cycles the chlorine dioxide setpoint ranges from 0.2 to 1 ppm, more preferred 0.2 to 0.8 ppm and most preferred 0.3 to 0.8 ppm.

For Routine Remediation cycles, the chlorine dioxide Ct Value ranges between 80 to 400 (mg/l×min), more preferred 90 to 300 (mg/l×min) and most preferred 100 to 250 (mg/l/min).

Implementation of Recovery Remediation cycles and Routine Remediation cycles can safely and effectively eliminate 100% of infections resulting from waterborne pathogens as well as Recreational Water Illness as disclosed by the Centers for Disease Control and Prevention.

The following terms used throughout the specification have the following meanings unless otherwise indicated.

“A” or “an” means “at least one” or “one or more” unless otherwise indicated.

“Comprise”, “have”, “include” and “contain” (and their variants) are open-ended linking verbs and allow the addition of other elements when used in a claim. “Consisting of” is closed, and excludes all additional elements.

“Consisting essentially of” excludes additional material elements, but allows the inclusions of non-material elements that do not substantially change the nature of the invention.

As used herein, “Remedial time-based proportional control” also “Remedial TBP” comprises a modified version of time-based proportional control that is configured to compensate for the high output ClO₂ feed systems required for the Recovery Remediation cycles and the subtle ClO₂ demands required by the Routine Remediation cycles, thereby allowing a single integrated chemical feed and process control system to effectively control Multiple Methods of Remediation cycles while operating within the completion time interval and ClO₂ Setpoint ranges established for the various methods.

Remedial time-based proportional control determines the chlorine dioxide feed system(s) ON-time following the equation:

$$[ \frac{{ClO}_{2} Setpoint ( ppm ) - Measured {ClO}_{2} ( ppm )}{{ClO}_{2} Dynamic \times 10 \times Dynamic Compensation} ] \times Time Segment = ON - Time$$

Where,
“Time Segment” is a segment of time reported in seconds or minutes (i.e. 60 seconds),
“ClO₂ Setpoint (ppm)” is the ClO₂ Setpoint for the selected remediation cycle,
“Measured ClO₂ (ppm)” is the ClO₂ value measured by the ClO₂ sensor,
“ClO₂ Dynamic” is the concentration of ClO₂ being applied to the water and is based on the total volume of water being treated per unit time (ClO₂ ppm/minute),
“Dynamic Compensation” (DC) is a unique value for each aquatic facility and compensates effects of lag-time on measurement of the chlorine dioxide concentration in the water by the chlorine dioxide sensor after chlorine dioxide has been fed to the water from the chlorine dioxide feed system, and the DC has a value ranging from 0.2 to 2.0.

As used herein, “Completion time interval” is the lapsed time from when the remediation cycle was initiated to when the targeted chlorine dioxide Ct Value is reached. Once the targeted Ct Value is reached, the remediation cycle is completed.

As used herein, “ClO₂ Dynamic” is the concentration of ClO₂ being applied to the water and is based on the total volume of water being treated per unit time (ClO₂ ppm/minute).

As used herein, “segment of time” is a period of time (exemplified by 60 seconds) used in determining the On-Time used for controlling the chlorine dioxide feed system.

As used herein, “minimum ON-Time” is a predetermined minimum period of time the chemical feed system will be turned ON. The minimum ON-Time overrides the On-Time value determined by the algorithm used to calculate the ON-Time if the calculated ON-Time value is lower than the minimum ON-Time. The use of the minimum ON-Time is used to prevent extremely short On-Time cycles (i.e. 1 second) that could potentially compromise the ability to properly control the chemical concentration due to mechanical limitations with the actuation of the chemical feed systems. Minimum ON-Time can be selected from about 1 to 5 seconds, and more preferred 2 to 4 seconds.

As used herein, “lag-time” is the time lapse (delay) from the time the chemical (i.e. chlorine dioxide) is applied to the water by the chemical feed system, to the time the sensor measures an increase in the chemical. For example, chlorine dioxide is applied to the water in conduit 33 that enters the swimming pool water 4. The chlorine dioxide disperses in the water and eventually some of the chlorine dioxide is taken into conduit 32 and supplied to conduit 36 where it is detected by the chlorine dioxide sensor 14. The time that lapsed between the application of chlorine dioxide to the time it was measured by sensor 14 is the lag-time.

As used herein, “Dynamic Compensation” also referred to as “DC” is swimming pool specific and compensates for the effect lag-time imparts on the measurement of ClO₂ by the chlorine dioxide sensor 14. DC is affected by turnover rate and has a value ranging from 0.2 to 2.0, with a default value of 1.0. The DC can be automatically adjusted by the process controller or can be manually input. The DC is particularly useful when the chemical feed systems impart a high ClO₂ Dynamic. DC can be automatically optimized using artificial intelligence (AI), wherein the AI tracks uses the lag-time and the amount (ppm) of chlorine dioxide overfeed. By monitoring these values, the AI can simulate adjustments to the DC (Optimized Value) and hone in the optimum Dynamic Compensation.

As used herein, “DC (Optimized Value)” is the Dynamic Compensation value resulting from the formula:

$$DC ( Optimized Value ) = Theoretical {ClO}_{2} ( ppm ) increase / Deviation from Setpoint ( ppm ) \times Y$$

### Where,

$$“ Theoretical {ClO}_{2} ( ppm ) increase ” = ( ON - Time / lag - time ) \times {ClO}_{2} Dynamic$$

$$“ Deviation from Setpoint ” = {ClO}_{2} Setpoint - Measured {ClO}_{2}$$

“Y” is the “Lag-time Adjustment” having a value ranging from 1.01 to 2.0, preferably 1.05 to 1.8, and most preferred 1.1 to 1.5.

The DC (Optimized Value) corrects for the site-specific effect of lag-time and tightens the ability of the integrated chemical feed and process control system to hone in on the ClO₂ Setpoint.

As used herein, “chlorine dioxide feed system(s)” is used to describe the chemical feed systems used to apply chlorine dioxide to the swimming pool water 4, and is often used in the context of controlling the feed systems using time-based proportional control. Chlorine dioxide chemical feed system(s) may comprise the chlorite ion donor feed system 26, acid feed system 28 and sanitizer feed system 30 when the chlorine dioxide is produced using in-situ generation. In the case where the chlorine dioxide is generated using a chlorine dioxide generator (chlorite ion donor) 26 represents the chlorine dioxide generator with chlorine dioxide being a chlorite ion donor.

As used herein, “sanitizer” also “free halogen sanitizer” describes free chlorine and/or free bromine. Sanitizer is interchangeable with disinfectant as the free chlorine and/or free bromine also kill virus, but sanitizer is often used as bacteria is the prominent microbiological contaminant tested for by the local Departments of Health.

As used herein, “setpoint” describes a targeted value (also referred to as “setpoint value”) the process controller tries to sustain. The setpoint is also used by the programmable control to compare to the measured value to determine how aggressively (ON-Time duration) to apply additional chemical treatments for pH control, chlorine dioxide and free halogen.

As used herein, the term “aquatic facility” is used with reference to all structural components and equipment comprising the swimming pool, piping, pumps, filter and heater to contain, circulate and treat the water used by humans and/or other mammals for swimming, exercise, sports and recreation. Examples of aquatic facilities include but are not limited to: water parks, feature pools, swimming pools, spas, therapy pools, hot tubs and other structures containing water for immersion by humans or mammals.

As used herein, the term “aqueous system” describes a body of water 4 that can be treated using the disclosed invention.

As used herein, “recreational water” is water 4 used by humans and/or mammals for various activities such as swimming, exercise, water sports, recreation, physical therapy and diving. Examples of recreational water include: swimming pools, hot tubs, feature pools, spas, water-park rides, therapy pools, diving wells, and other structures containing water for immersion by humans or mammals.

As used herein the term “chlorine dioxide Ct value” is defined as the product of the average concentration of chlorine dioxide (mg/l) and time (minutes) of exposure to the chlorine dioxide. For example, if the average chlorine dioxide concentration of ClO₂ is determined to be 2.2 mg/l over a 20 minute period of time, the chlorine dioxide Ct value is calculated by multiplying the average concentration of chlorine dioxide by the time.

$$Chlorine dioxide Ct value = 2.2 mg / l \times 20 min$$

$$Chlorine dioxide Ct value = 44 ( mg / l \times min )$$

As used herein, “algorithm to calculate the chlorine dioxide Ct value” describes a mathematical equation for calculating the chlorine dioxide Ct value in near real-time. One example of a suitable algorithm for calculating the chlorine dioxide Ct value follows:

$$Chlorine dioxide Ct value = [ ( \sum {X}_{n} ) \div n ] \times T$$

Where:
“Xₙ” is the chlorine dioxide concentration in mg/l (or ppm) recorded at a point in time since beginning the remediation cycle.
“n” is the number of chlorine dioxide values recorded over a period of time since beginning the remediation cycle.
“T” is the period of time (minutes) that has lapsed since beginning the remediation cycle.

As used herein, “rolling average” is the average chlorine dioxide concentration resulting from the accumulated (sum) chlorine dioxide concentrations (mg/l) divided by the number of chlorine dioxide measurements by the chlorine dioxide sensor 14 and recorded. The rolling average is used to provide a real-time chlorine dioxide Ct value by multiplying the rolling average by the lapsed time (i.e. number of minutes since beginning the calculation of the chlorine dioxide Ct value). The rolling average can be updated over any desired period of lapsed time. One preferred period of lapsed time ranges from 0.1 to 60 minutes, more preferred 0.2 to 30 minutes, and most preferred 0.5 to 10 minutes.

As used herein, the term “remediation cycle” describes the process of treating the water of an aquatic facility with chlorine dioxide, resulting in mixed halogen-based treatment comprising chlorine dioxide and free halogen to obtain a targeted chlorine dioxide Ct value (min×mg/l) to achieve remediation. Remediation cycles have the steps of initiation, implementation and termination when the targeted Ct Value is achieved.

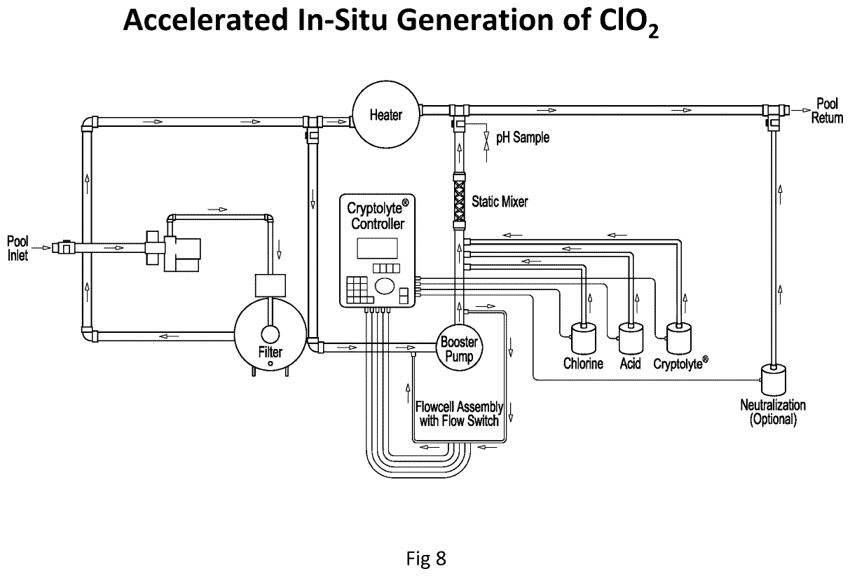

As used herein, “accelerated in-situ generation of chlorine dioxide” describes delivering chemicals for the in-situ generation of chlorine dioxide using methods disclosed in Co-pending application Ser. Nos. 17/866,823, 17/988,963 and 17/571,586 and exemplified in FIG. 8. Accelerated in-situ generation of chlorine dioxide comprises creating localized high concentrations of chemicals for generating chlorine dioxide. Accelerated in-situ generation of chlorine dioxide eliminates the need for a chlorine dioxide generator by using the existing conduit or a side-stream in fluid contact with the existing conduit of the pools circulating system.

As used herein, “localized high concentrations” refers to the concentration of chemicals used for the generation of chlorine dioxide within the conduit. The volume of water in the conduit is only a small portion of the volume of water in the swimming pool. When the said chemicals are applied to the conduit, the concentration in the conduit may be 100's of times higher than what will be achieved once the chemicals are dispersed in the large volume of water in the swimming pool. For example, a 100,000 gallon swimming pool is required to have a turnover every 6 hours or less to meet typical Dept of Health codes. A circulation rate of approximately 280 gpm is required. If the process controller is programmed to feed sufficient chemical to produce 5 ppm as ClO₂ based on the volume of water in the pool and the chemicals are feed over three minutes, the localized high concentrations within the conduit are sufficient to produce approximately 119 ppm as ClO₂. By utilizing accelerated in-situ generation of chlorine dioxide, localized high concentrations of reactant chemicals result in high conversion efficiency without the use of a chlorine dioxide generator.

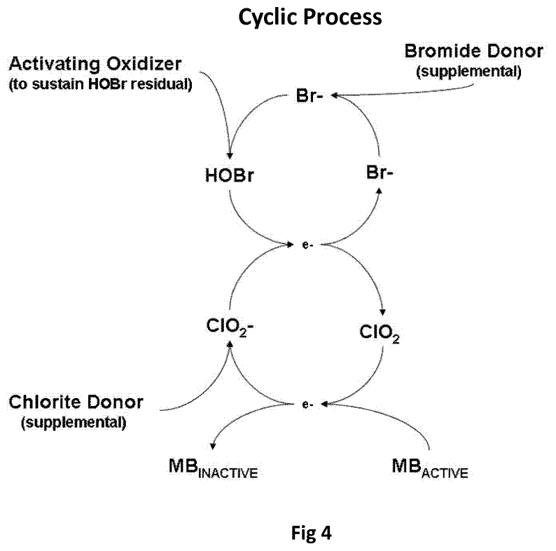

As used herein, the term “cyclic process” describes the in-situ generation of chlorine dioxide resulting from hypobromous acid activation of chlorite, followed by the recycling of substantially inert anions comprising bromide and chlorite. The bromide and chlorite are then oxidized into their oxyhalogen surrogates, exemplified by hypobromous acid and chlorine dioxide respectfully followed by reduction back to their respective anions, and where the process is repeated (FIG. 4). The cyclic process comprises activating bromide ions with the oxidant to produce free bromine, the free bromine oxidizes chlorite ions to produce chlorine dioxide, reducing at least some free bromine back to bromide ions and repeating the process. Chlorite ions resulting from the reduction of chlorine dioxide are also recycled back to chlorine dioxide in the cyclic process.

As used herein “hypobromous acid activation of chlorite” describes how the cyclic process in-situ generates chlorine dioxide from chlorite. The cyclic process as previously described in a multi-step process that makes efficient use of the chlorite. However, the in-situ generation of chlorine dioxide resulting from the cyclic process is the direct result of hypobromous acid activation of chlorite.

As used herein, “UV activation” and “UV activation of chlorite” is a method for in-situ generation of chlorine dioxide from chlorite that is especially suitable for outdoor pools during normal daylight hours when most recreational water facilities are being used by swimmers and bathers. The method exploits the benefits of sunlight's UV to accelerate the generation of chlorine dioxide. Addition of a chlorite donor to the aqueous system exposed to sunlight results in the in-situ generation of chlorine dioxide by ultraviolet (UV) light induced photolysis (decomposition) of chlorite ions according to the proposed stoichiometry:

3ClO₂⁻+H₂O+hv→Cl⁻+2ClO₂+2OH⁻+0.5O₂

This method of in-situ generating chlorine dioxide is beneficial while the pool is in use by applying chlorite into the pool thru the return ports of the circulating system. This eliminates the injection of chlorine dioxide gas into the pool while swimmers are present.

As used herein, the term “chlorite ion donor” and “chlorite donor” is a compound that comprises an alkali metal salt comprising chlorite anions ClO₂⁻, chlorine dioxide, or any convenient direct or indirect source of chlorite anions. For example, chlorine dioxide can indirectly produce chlorite due to its reduction in an aqueous system. Sodium chlorite directly supplies chlorite anions.

As used herein, the term “chlorite ion” and “chlorite anion” (also referred to as “chlorite”) comprises chlorite having the general formula ClO₂⁻. The chlorite is the anion released when sodium chlorite is dissolved in water and converts to chlorine dioxide.

As used herein, the term “recycled” means at least some portion of the recovered bromide ions and chlorite ions are regenerated to their respective oxyhalogen compounds, followed by reduction back to their respective anions, and where the process is repeated.

As used herein, the term “Cryptosporidium” is used to represent any form of parasitic microbiological organism from the family of Cryptosporidium. An example of Cryptosporidium is Cryptosporidium parvum (also referred to as C. parvum, C. parvum and Cryptosporidium parvum). Other examples of Cryptosporidium include but are not limited to: C. hominis, C. canis, C. felis, C. meleagridis, and C. muris. It is to be noted that inclusion or exclusion of italic characters or print when referring to Cryptosporidium or any of its many variants does not in any way detract from its intended descriptive meaning.

As used herein, the term “microbiological organisms” is used with reference to all forms of microbiological life including: parasites, bacteria, viruses, algae, fungus, and organisms encased in biofilms.

As used herein, “parasites” includes any species of organism including Cryptosporidium, Giardia and Ameba that can be transferred to humans by water and cause waterborne parasitic disease in humans.

As used herein, the term “inactivation” is used with reference to the ability to deactivate, kill, or destroy microbiological organisms.

As used herein, “remediation” is defined as the ability to reduce the level of waterborne pathogens and/or algae to levels at or below that deemed acceptable by various regulatory agencies exemplified by the Departments of Health, U.S. Environmental Protection Agency, and/or the Centers for Disease Control and Prevention. Examples of achieving remediation comprise at least one of the following: less than 1 CFU per ml of viable bacteria determined by heterotrophic plate count; greater than or equal to a 3-log reduction of parasites such as Cryptosporidium, and/or rendering the aqueous system free of algae.

As used herein, “process controller” 24 describes a control system that interfaces with sensors and chemical feed systems for the chemical treatment of water of an Aquatic Facility.

Non-limiting examples of how the process controller 24 can be used to control chemical feed systems 40 includes: actuating chemical feed; varying the rate of chemical feed; energizing an electronic device such as a chemical feed pump, solenoid valve; stopping chemical feed; and initiating a neutralization cycle that removes residual chemicals from the water using neutralizing chemicals exemplified by sodium sulfite. The process controller 24 receives inputs either manually and/or automatically from sensors exemplified by the non-limiting examples: pH sensor 12, ORP sensor 8, amperometric sensor 10, chlorine dioxide sensor 14, temperature sensor 16, flow sensor 17, flow switch and the like.

The process controller 24 uses some form of control logic to control and optimize the feed of chemicals. Examples of control logic include: time-based proportional, proportional, on/off etc.

As used herein, “fluid contact” describes contact between conduits 32, 33 capable of transporting liquid to and from the main body of water (i.e. swimming pool) 4 at the aquatic facility. Specifically, regarding aquatic facilities, sensors and chemical feed systems 40 are in fluid contact with the water 4 of an aquatic facility in or near the mechanical room where water is recovered from the pool, filtered 20, sometime heated 22 and returned to the pool. The piping (conduit) 36 transporting the water supplies water for the sensors to monitor the various parameters such as pH 12, sanitizer concentration 8, 10, temperature 16 and chlorine dioxide 14. Chemical feed 40 is generally applied into the return piping 33 after being filtered and where applicable heated to prevent corrosion of the heater 22.

As used herein, “chemical feed systems” 40 describe any convenient device that is fluid contact with both the chemicals and the water of the aquatic facility. The chemical feed systems 40 can be controlled to deliver the desired amount of chemicals exemplified by the non-limiting examples chlorine, bromine, acid such as HCl or CO₂ and chlorite ion donor such as sodium chlorite and/or chlorine dioxide. Non-limiting examples of chemical feed systems include: chemical metering pumps, educators, modulating control valves, electrolysis device and the like.

As used herein, “flow sensor” 17 describes a device that can detect a liquid flowing through a pipe or conduit 36. The flow sensor 17 can be a flow transmitter that measures the flow rate, but is not required to measure the flow rate. The flow sensor 17 detects motive water in the pipe or conduit 36. One non-limiting example of a flow sensor that does not measure the flow rate is a Rotorflow® Flow Sensor available by Gems™ Sensors and Controls.

As used herein, “actuated” and “actuating” and its variations is an action initiated by the process controller 24 to cause something to happen such as initiating chemical feed, stopping chemical feed, initiating a neutralization cycle and the like.

As used herein, the term “free chlorine” describes the presence of hypochlorous acid and/or hypochlorite ions when a chlorine donor is dissolved in water. The predominant species of free chlorine is dependent on the pH of the water. At pool water pH of 7.2 to 7.8 free chlorine comprises both hypochlorous acid (HOCl) and hypochlorite ions (OCl⁻). However, when the pH is lowered with acid such as in the case of applying the accelerated in-situ generation of chlorine dioxide, the predominant species of free chlorine in the conduit of the circulating system is hypochlorous acid (HOCl). Sources of free chlorine include sodium hypochlorite, calcium hypochlorite, dichloroisocyanuric acid, trichloroisocyanuric acid, lithium hypochlorite as well as electrolysis devices the convert chloride ions to free chlorine in water.

As used herein, the term “free bromine” is used with reference to the formation or presence of hypobromous acid and possibly some portion of hypobromite ions, depending on the pH. At pool water pH most of the free bromine is hypobromous acid.

As used herein, the term “free halogen” is used with reference to a halogen-based sanitizer that hydrolyses into various halogen-based species when dissolved in water. Chlorine based free halogen comprises HOCl, and OCl⁻ (also referred to as free chlorine) when a chlorine donor is dissolved in water at pool water pH (7.2-7.8). Bromine based free halogen forms HOBr, and OBr (also referred to as free bromine), when a bromine donor is dissolved in water at pool water pH.

As used herein, the term “oxidizer” is used to describe a chemical capable of oxidizing bromide ions to form free bromine and/or chloride ions to free chlorine. The oxidizer can comprise bromide ions and/or free bromine. The oxidizer can be a sanitizer exemplified by calcium hypochlorite, sodium hypochlorite, lithium hypochlorite and the like. One non-limiting example of an oxidizer comprising bromide ion donor is TowerBrom® 90M sold by Occidental Chemical Corporation. Other non-limiting examples of oxidizers include potassium monopersulfate, trichloroisocyanurate, dichloroisocyanurate, 1-Bromo-3-chloro-5,5-dimethylhydantoin and the like. Electrolysis of chloride ions to produce free chlorine is also a suitable oxidizer.

As used herein, the term “inactivation” is used with reference to the ability to deactivate, kill, or destroy microbiological organisms.

As used herein, the term “microbiological organisms” is used with reference to all forms of microbiological life forms including: parasites, bacteria, viruses, algae, fungus, and organisms encased in biofilms.

As used herein, “sensor for controlling the feed of sanitizer” is used with reference to ORP and/or amperometric sensors that are in fluid contact with the water of an aquatic facility, and provide measurements used for controlling the feed of a sanitizer (e.g. chlorine and/or bromine). While only one sensor is used to control the sanitizer at any given time, it is beneficial to monitor both ORP and free chlorine.

As used herein, “amperometric sensor” 10 describes a device that is in fluid contact with the water of an aquatic facility and is used to measure the concentration of sanitizer exemplified by free chlorine. The amperometric sensor 10 can be used to control the feed of sanitizer.

As used herein, “chlorine dioxide sensor” 14 describes a device that is in fluid contact with the water 4 of an aquatic facility and is used to measure the chlorine dioxide concentrated used to remediate the aquatic facility. Generally, the chlorine dioxide sensor 14 is an amperometric sensor that incorporates a gas permeable membrane that allows chlorine dioxide gas to permeate the membrane while isolating the sensor from hydrolyzed oxidizers like chlorine. The chlorine dioxide sensor 14 can be any suitable sensor that can be used to selectively measure the chlorine dioxide. One example of another type of chlorine dioxide sensor is a colorimetric device that utilizes lissamine green reagents to selectively measure chlorine dioxide in the presence of sanitizers, or new technologies that use solid state sensors that are selective to chlorine dioxide.

As used herein, “ORP sensor” 8 describes a device that is in fluid contact with the water of an aquatic facility and is used to measure the Oxidation Reduction Potential (ORP) of the water 4. ORP sensor 8 can be sued to control the feed of sanitizer. The ORP sensor does not directly measure the presence of free halogen. The ORP sensor is influenced by contaminants in the water that impart an oxidant demand on the free halogen. Therefore, ORP is a means of determining the “relative concentration” of free halogen in the water. However, ORP is a very effective means of controlling the free halogen concentration for use as a sanitizer.

As used herein, “chemical feed systems” 40 describes in broad terms any desirable means for applying chemicals to the water 4 of an aquatic facility. Non-limiting examples of chemical feed systems include: chemical metering pumps, educators, erosion feeders such as a chlorinator or brominator, electrolysis device for producing chlorine from sodium chloride in the water and a chlorine dioxide generator for ex-situ generation of chlorine dioxide.

As used herein, “Heterotrophic plate count (HPC) is also known by a number of other names, including standard plate count, total plate count, total viable count or aerobic quality count. It does not differentiate between the types of bacteria present nor does it indicate the total number of bacteria present in the water—only those capable of forming visible colonies under specified conditions on certain non-selective microbiological media. Varying the incubation temperature will favor the growth of different groups of bacteria. As it gives more meaningful information about pathogenic (disease-causing) bacteria, 35° C. (or 37° C.) is the preferred incubation temperature. HPC does not necessarily indicate microbiological safety as the bacteria isolated may not have been faecally-derived but it does give a measure of the overall general quality of the pool water, and whether the filtration and disinfection systems are operating satisfactorily. Results reported by the laboratory are traditionally expressed as colony forming units per millilitre (CFU/mL) which equates to the number of bacteria in each millilitre of the original sample of water. A HPC count of less than 1 CFU/mL indicates that the disinfection system is effective. If the count is between 10 and 100 CFU/mL, a routine investigation should be conducted as soon as possible to ensure that all the management operations are functioning properly.

As used herein, “CFU” (Colony Forming Units) is a unit used in microbiology to estimate the number of viable bacteria or fungal cells in a sample.

Algorithms can be programmed into the process controller for achieving compliance with the Dept of Health regulations for swimming pool water quality. Once the sensors detect the swimming pool water is within the compliance, process controller can notify the appropriate personnel that the pool is ready for use by patrons. Controller display can signal the pool is ready for opening and/or remote communications can notify managers via a call or an app to their phones or computers.

EXAMPLES of optimization of the Dynamic Compensation which compare the same control scenarios using different lag-times, then optimizing the Dynamic Compensation to tighten the chlorine dioxide control.

### Example #1

Lag-time 7 min, Deviation from Setpoint=0.1 ppm ClO₂
Theoretical ClO₂ (ppm) increase

$$ON - Time = ( 0.1 ppm / [ 0.25 ppm / min {ClO}_{2} \times 10 \times 1. ] ) \times 60 s = 2.4 s / min$$

$$Theoretical {ClO}_{2} increase = 2.4 s / 60 ( s / min ) \times 7 min ( lag - time ) \times 0.25 ppm / min {ClO}_{2} = 0.07 ppm {ClO}_{2}$$

$$\begin{matrix}DC ( Optimized Value ) = Theoretical {ClO}_{2} ( ppm ) increase / Deviation \\ from Setpoint \times 1.5 ( preferred 50 \% ) \\ = 0.07 {ClO}_{2} ( ppm ) / 0.15 \\ = 0.47\end{matrix}$$

### Example #2

Lag-time 15 min, Deviation from Setpoint=0.1 ppm ClO₂
Theoretical ClO₂ (ppm) increase

$$ON - Time = ( 0.1 ppm / [ 0.25 ppm / min {ClO}_{2} \times 10 \times 1. ] ) \times 60 s = 2.4 s / min$$

$$15 minute total {ClO}_{2} = 2.4 s / 60 ( s / min ) \times 15 min ( lag - time ) \times 0.25 ppm / min {ClO}_{2} = 0.15 ppm {ClO}_{2}$$

### Example #3

Lag-time 25 min, Deviation from Setpoint=0.1 ppm ClO₂
Theoretical ClO₂ (ppm) increase

$$\begin{matrix}ON - Time = ( 0.1 ppm / [ 0.25 ppm / min {ClO}_{2} \times 10 \times 1. ] ) \times 60 s \\ = 2.4 s / min \\ 25 minute total {ClO}_{2} = 2.4 s / 60 ( s / min ) \times 25 min ( lag - time ) \times \end{matrix}$$

$$\begin{matrix}0.25 ppm / min {ClO}_{2} \\ = 0.25 ppm {ClO}_{2}\end{matrix}$$

$$\begin{matrix}DC ( Optimized Value ) = Theoretical {ClO}_{2} ( ppm ) increase / \\ Deviation from Setpoint \times 1.5 ( preferred 50 \% ) \\ = 0.25 {ClO}_{2} ( ppm ) / 0.15\end{matrix}$$

$$= 1.67$$

Check with Higher Deviation
Theoretical ClO₂ (ppm) increase

$$\begin{matrix}ON - Time = ( 0.3 ppm / [ 0.25 ppm / min {ClO}_{2} \times 10 \times 1.67 ] ) \times \\ 60 s = 4.31 s / min \\ 25 minute total {ClO}_{2} = 4.31 s / 60 ( s / min ) \times 25 min ( lag - time ) \times \end{matrix}$$

$$\begin{matrix}0.25 ppm / min {ClO}_{2} \\ = 0.45 ppm {ClO}_{2}\end{matrix}$$

### PERFORMANCE EXAMPLES

An outdoor 50,000 gallon pool is equipped with a feed system for in-situ generation of chlorine dioxide having a ClO₂ Dynamic of 0.25 ppm/min of ClO₂ based on the total pool volume of 50,000 gal. Based on a circulation rate of 139 gpm, the turnover rate for the pool is 6 hrs. The lag-time is determined to be 15 minutes.

Continuous 24/7 Remediation cycles are used for the ongoing treatment of the water to provide maximum protection from microbiological activity as well as inhibiting formation and accumulation of DBPs. The chlorine dioxide setpoint is 0.5 ppm as ClO₂.

### Comparing Performance of Control Models

### On/Off Control

ON/OFF control allows the chemical feed systems to operate ON 100% of the time when the measured value falls below the setpoint. In this scenario, a ClO₂ Dynamic of 0.25 ppm/min ClO₂, the ppm of chlorine dioxide applied in 15 minutes is calculated as follows:

$$\begin{matrix}Deviation from Setpoint = 0.1 ppm {ClO}_{2} \\ 15 min {total ClO}_{2} = 15 min \times 0.25 ppm / min {ClO}_{2} \\ = 3.75 ppm {ClO}_{2}\end{matrix}$$

Using ON/OFF control, by the time the chlorine dioxide sensor begins detecting the ClO₂, the concentration of ClO₂ is approximately 7.5× higher than the setpoint, making the water un-safe for use by bathers.

If the chemical feed systems were manually set to 10% of their maximum output, the chlorine dioxide concentration would increase by 0.375 ppm in the same 15 minute period. However, when a Recovery Remediation cycle is implemented requiring a Ct value of 200 (mg/l×min), the time to complete the remediation would require 5 hrs or more depending on the UV depletion rate of the chlorine dioxide. In this case, a secondary chemical feed system would be required to provide Recovery Remediation cycles, increasing capital expense, and would be unlikely due to space limitation in often space limited mechanical rooms.

### Time-Based Proportional Control

Time-based Proportional (TBP) is incorporated into controllers used for swimming pools, examples include the BECSys5 and BECSys7 controllers manufactured by BECS Technologies, Inc. located in St. Louis, MO.

The TBP control applies a SPAN that consist of a numeric value representing the deviation (decrease) from the Setpoint at which the process controller activates the chemical feed system(s) ON for 100% of the time. When the deviation is less than the SPAN value, the ON-Time is proportional to the deviation and is represented by equation:

$$ON - Time = ( Deviation / SPAN ) \times 60 seconds .$$

The SPAN default value is set at approximately 25-35% of the anticipated Setpoint value. For example, a typical chlorine setpoint of 1.5 to 2.0 ppm as Cl₂ has a SPAN default value of 0.5.

Appling the model to the Continuous 24/7 Remediation cycle example, a Setpoint of 0.5 ppm CO₂ would have a SPAN of about 0.1 to 0.2 with 0.3 as an outlier.

Applying these SPAN values and using the equation:

$$ON - Time = Deviation / SPAN \times 60 seconds .$$

$$Deviation from Setpoint = 0.1 ppm {ClO}_{2}$$

$$\begin{matrix}ON - Time = 0.1 ppm / 0.1 ( SPAN ) \times \\ 60 s = 60 s / min\end{matrix}$$

$$\begin{matrix}15 minute total {ClO}_{2} = 60 s / 60 ( s / min ) \times 15 min ( lag - time ) \times \\ 0.25 ppm / min {ClO}_{2} \\ = 3.75 ppm {ClO}_{2}\end{matrix}$$

$$Deviation from Setpoint = 0.1 ppm {ClO}_{2}$$

$$\begin{matrix}ON - Time = 0.1 ppm / 0.2 ( SPAN ) \times \\ 60 s = 30 s / min\end{matrix}$$

$$\begin{matrix}15 minute total {ClO}_{2} = 30 s / 60 ( s / min ) \times 15 min ( lag - time ) \times \\ 0.25 ppm / min {ClO}_{2} \\ = 1.875 ppm {ClO}_{2}\end{matrix}$$

$$Deviation from Setpoint = 0.1 ppm {ClO}_{2}$$

$$\begin{matrix}ON - Time = 0.1 ppm / 0.3 ( SPAN ) \times \\ 60 s = 20 s / min\end{matrix}$$

$$\begin{matrix}15 minute total {ClO}_{2} = 20 s / 60 ( s / min ) \times 15 min ( lag - time ) \times \\ 0.25 ppm / min {ClO}_{2} \\ = 1.25 ppm {ClO}_{2}\end{matrix}$$

### Remedial Time-Based Proportional Control

$$[ \frac{{ClO}_{2} Setpoint ( ppm ) - Measured {ClO}_{2} ( ppm )}{{ClO}_{2} Dynamic \times 10 \times Dynamic Compensation} ] \times Time Segment = ON - Time$$

where,
“Dynamic Compensation” ranges between 0.5 and 2.0, with a preferred default of 1.0.

$$Deviation from Setpoint = 0.1 ppm {ClO}_{2}$$

$$\begin{matrix}ON - Time = ( 0.1 ppm / [ 0.25 ppm / min {ClO}_{2} \times 10 \times 1. ] ) \times 60 s \\ = 2.4 s / min \\ 15 minute total {ClO}_{2} = 2.4 s / 60 ( s / min ) \times \end{matrix}$$

$$\begin{matrix}15 min ( lag - time ) \times 0.25 ppm / min {ClO}_{2} \\ = 0.15 ppm {ClO}_{2}\end{matrix}$$

$$Deviation from Setpoint = 0.2 ppm {ClO}_{2}$$

$$\begin{matrix}ON - Time = ( 0.2 ppm / [ 0.25 ppm / min {ClO}_{2} \times 10 \times 1. ] ) \times 60 s \\ = 4.8 s / min \\ 15 minute total {ClO}_{2} = 4.8 s / 60 ( s / min ) \times \end{matrix}$$

$$\begin{matrix}15 min ( lag - time ) \times 0.25 ppm / min {ClO}_{2} \\ = 0.3 ppm {ClO}_{2}\end{matrix}$$

$$Deviation from Setpoint = 0.3 ppm {ClO}_{2}$$

$$\begin{matrix}ON - Time = ( 0.3 / [ 0.25 ppm / min {ClO}_{2} \times 10 \times 1. ] ) \times 60 s \\ = 7.2 s / min \\ 15 minute total {ClO}_{2} = 7.2 s / 60 ( s / min ) \times \end{matrix}$$

$$\begin{matrix}15 min ( lag - time ) \times 0.25 ppm / min {ClO}_{2} \\ = 0.45 ppm {ClO}_{2}\end{matrix}$$

### Results

Comparing similar range deviation from the setpoint, both ON/OFF and Time-based proportional control resulted in excessive (unacceptable) overfeed of chemical treatment making the water un-safe for use.

The Remedial Time-based proportional control achieved very tight control allowing the integrated chemical feed and process control system to effectively implement Recovery Remediation cycles while also effectively and safely controlling Routine Remediation cycles even while bathers are present.

Programming the process controller to implement Remedial time-based proportional control and integrating the process controller with sensors and chemical feed system provides a means for controlling Multiple Methods of Remediation cycles having different completion time intervals and Setpoint ranges, resulting in unprecedented ability to remediate the water while the swimming pool is in use, as well as implement Recovery Remediation to remove bio-films as well as rapidly remediate from a fecal release. Furthermore, implementation of this advancement in swimming pool treatment technology only requires upgrading the existing systems by implementing a Remedial TBP programmed microprocessor chip in the process controller, integrating a chlorine dioxide sensor and installing a chlorite ion donor feed system for applying chlorine dioxide. Low cost and ease of implementation greatly enhance the potential for mitigating Recreational Water Illness.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, steps and/or embodiments, the invention is not intended to be limited to the particulars disclosed herein. Rather, the invention extends to all functionally equivalent structures, processes and uses, such as are within the scope of the appended claims. Those skilled in the art, having the benefit of the teachings of this specification, may affect numerous modifications thereto and changes may be made without departing from the scope and spirit of the invention.

1. An integrated system for controlling multiple methods of remediation cycles for the treatment of water of an aquatic facility for immersion by humans, the integrated system comprising:
a chlorine dioxide sensor in fluid communication with the water;
a chlorine dioxide feed system in fluid communication with the water, the chlorine dioxide feed system is downstream of the chlorine dioxide sensor, and chlorine dioxide is fed to the water during ON-Time;
a process controller in communication with the chlorine dioxide sensor and the chlorine dioxide feed system for measurement and control of chlorine dioxide in the water;
the process controller is programmed to control recovery remediation cycles and routine remediation cycles of the water, the recover remediation cycles having a different completion time interval and ClO₂ Setpoint than the routine remediation cycles, and completion of the recovery remediation cycles and the routine remediation cycles is determined by achieving a targeted chlorine dioxide CT Value in the water;
the process controller is programmed to control the chlorine dioxide feed system using remedial time-based proportional control (remedial TBP), wherein the remedial TBP determines the chlorine dioxide feed system ON-Time following the formula:
$$[ \frac{{ClO}_{2} Setpoint ( ppm ) - Measured {ClO}_{2} ( ppm )}{{ClO}_{2} Dynamic \times 10 \times Dynamic Compensation} ] \times Time Segment = ON - Time$$
where,
Time Segment is a segment of time reported in seconds or minutes;
ClO₂ Setpoint (ppm) is the ClO₂ Setpoint for the selected routine remediation cycle or recovery remediation cycle;
Measured ClO₂ (ppm) is the ClO₂ value measured by a chlorine dioxide sensor;
ClO₂ Dynamic is a concentration of ClO₂ being fed to the water from the chlorine dioxide feed system and is based on a total volume of water being treated per unit time (ClO₂ ppm/minute); and
Dynamic Compensation (DC) is a unique value for each aquatic facility and compensates effects of lag-time on measurement of the chlorine dioxide concentration in the water by the chlorine dioxide sensor after chlorine dioxide has been fed to the water from the chlorine dioxide feed system, and the DC has a value ranging from 0.2 to 2.0.

2. The system in accordance with claim 1, wherein the Dynamic Compensation value is 1.0.

3. The system in accordance with claim 1, further comprising optimizing the Dynamic Compensation following the formula:
$$DC ( Optimized Value ) = Theoretical {ClO}_{2} ( ppm ) increase / Deviation from Setpoint ( ppm ) \times Y$$
Where,
$$“ Theoretical {ClO}_{2} ( ppm ) increase ” = ( ON - Time / Time segment ) \times lag - time \times {ClO}_{2}$$
Dynamic
“Deviation from Setpoint”=ClO₂ Setpoint-Measured ClO₂
“Y” is the “Lag-time Adjustment” having a value ranging from 1.01 to 2.0, preferably 1.05 to 1.8, and most preferred 1.1 to 1.5.

4. The system in accordance with claim 3, wherein the Dynamic Compensation is automatically optimized by the process controller.

5. The system in accordance with claim 3, wherein the Dynamic Compensation is optimized manually.

6. The system in accordance with claim 1, wherein the Recovery Remediation cycle having a completion time interval ranging between 0.25 to 3.5 hours and a ClO₂ Setpoint ranging from 2 to 20 ppm.

7. The system in accordance with claim 6, wherein the ClO₂ Setpoint ranges from 3 to 15 ppm.

8. The system in accordance with claim 7, wherein the ClO₂ Setpoint ranges from 4 to 10 ppm.

9. The system in accordance with claim 1, wherein the Routine Remediation cycle having a completion time interval ranging between 3.5 to 24 hours and a ClO₂ Setpoint ranging from 0.2 to 1.0 ppm.

10. The system in accordance with claim 9, wherein the ClO₂ Setpoint ranges from 0.2 to 0.8 ppm.

11. The system in accordance with claim 10, wherein the ClO₂ Setpoint ranges from 0.3 to 0.6 ppm.

12. The system in accordance with claim 6, wherein the Recovery Remediation further comprises a Biofilm Remediation cycle and a Shock Remediation cycle.

13. The system in accordance with claim 12, wherein the Bio-film Remediation cycle having a chlorine dioxide CT Value ranges from 300 to 3000 (mg/l×min).

14. The system in accordance with claim 13, wherein the chlorine dioxide CT Value ranges from 400 to 2500 (mg/l×min).

15. The system in accordance with claim 14, wherein the chlorine dioxide CT Value ranges from 500 to 2000 (mg/l/min).

16. The system in accordance with claim 12, wherein the Shock Remediation cycle having a chlorine dioxide CT Value ranges from 80 to 400 (mg/l×min).

17. The system in accordance with claim 16, wherein the chlorine dioxide CT Value ranges from 90 to 350 (mg/l×min).

18. The system in accordance with claim 17, wherein the chlorine dioxide CT Value ranges from 100 to 300 (mg/l/min).

19. The system in accordance with claim 1, wherein controlling the Recovery Remediation cycle comprising:
the process controller initiating the Recovery Remediation cycle;
measuring the chlorine dioxide concentration and calculating a chlorine dioxide Ct value;
sustaining the concentration of chlorine dioxide until the targeted chlorine dioxide Ct value is achieved;
and the process controller recordings
the time when the targeted chlorine dioxide Ct value is achieved and terminating the remediation cycle.

20. The system in accordance with claim 1, wherein the Routine Remediation cycle further comprises a Daily Remediation cycle and/or Continuous 24/7 Remediation cycles.

21. The system in accordance with claim 20, wherein the Routine Remediation cycle having a chlorine dioxide CT Value ranges from 80 to 400 (mg/l×min).

22. The system in accordance with claim 21, wherein the chlorine dioxide CT Value ranges from 90 to 300 (mg/l×min).

23. The system in accordance with claim 22, wherein the chlorine dioxide CT Value ranges from 100 to 250 (mg/l/min).

24. The system in accordance with claim 20, wherein controlling the Daily Remediation cycles comprising:
the process controller initiating the Daily Remediation cycle;
measuring the chlorine dioxide concentration;
calculating a chlorine dioxide Ct value;
sustaining the concentration of chlorine dioxide until the targeted chlorine dioxide Ct value is achieved;
and the process controller recording the time when the targeted chlorine dioxide Ct value is achieved and terminating the remediation cycle.

25. The system in accordance with claim 20, wherein controlling the Continuous 24/7 Remediation cycles comprising:
the process controller initiating the Continuous 24/7 Remediation cycles;
measuring the chlorine dioxide concentration;
calculating a chlorine dioxide Ct value;
sustaining the concentration of chlorine dioxide until the targeted chlorine dioxide Ct value is achieved,
and wherein the process controller records the time when the targeted chlorine dioxide Ct value is achieved terminating the remediation cycle, resets the chlorine dioxide Ct value to zero, then repeats the process.

26. The system in accordance with claim 1, further comprising setting the chlorine dioxide chemical feed system(s) to their maximum output.

27. The system in accordance with claim 1, further comprising controlling the sanitizer and pH control feed systems using time-based proportional control.

28. The system in accordance with claim 1, further comprising sensors for measuring ORP, free chlorine, total chlorine, temperature and flow rate of the circulating water.

29. The system in accordance with claim 1, wherein the chlorine dioxide feed system for control of chlorine dioxide comprises a chlorine dioxide generator.

30. The system in accordance with claim 1, wherein the chlorine dioxide feed system comprises accelerated in-situ generation of chlorine dioxide.

31. The system in accordance with claim 1, wherein the chlorine dioxide Ct value is calculated following the equation:
$$Chlorine dioxide Ct value = [ ( \sum {X}_{n} ) \div n ] \times T$$
Where:
“Xₙ” is the chlorine dioxide concentration in mg/l (or ppm) recorded at a point in time since beginning the remediation cycle.
“n” is the number of chlorine dioxide values recorded over a period of time since beginning the remediation cycle.
“T” is the period of time (minutes) that has lapsed since beginning the remediation cycle.

32. The system in accordance with claim 1, wherein the chlorine dioxide Ct Value is calculated following the equation:
$$Chlorine dioxide Ct value = \sum [ ( \sum {X}_{n} \div n ) \times T ]$$
Where:
“Xₙ” is the chlorine dioxide concentration in mg/l (or ppm) recorded at a point in time over the sampling period.
“n” is the number of chlorine dioxide values recorded over the sampling period.
“T” is the period of time (minutes) that has lapsed over the sampling period.

33. A method for controlling multiple methods of remediation cycles for the treatment of water of an aquatic facility for immersion by humans, the method comprising:
providing an integrated system comprising:
a chlorine dioxide sensor in fluid communication with the water;
a chlorine dioxide feed system in fluid communication with the water, the chlorine dioxide feed system is downstream of the chlorine dioxide sensor, and chlorine dioxide is fed to the water during ON-Time;
a process controller in communication with the chlorine dioxide sensor and the chlorine dioxide feed system for measurement and control of chlorine dioxide in the water;
the process controller is programmed to control recovery remediation cycles and routine remediation cycles of the water, the recover remediation cycles having a different completion time interval and ClO₂ Setpoint than the routine remediation cycles, and completion of the recovery remediation cycles and the routine remediation cycles is determined by achieving a targeted chlorine dioxide CT Value;
the process controller is programmed to control the chlorine dioxide feed system using remedial time-based proportional control (remedial TBP), wherein the remedial TBP determines the chlorine dioxide feed system ON-Time following the formula:
$$[ \frac{{ClO}_{2} Setpoint ( ppm ) - Measured {ClO}_{2} ( ppm )}{{ClO}_{2} Dynamic \times 10 \times Dynamic Compensation} ] \times Time Segment = ON - Time$$
where,
Time Segment is a segment of time reported in seconds or minutes;
ClO₂ Setpoint (ppm) is the ClO₂ Setpoint for the selected routine remediation cycle or recovery remediation cycle;
Measured ClO₂ (ppm) is the ClO₂ value measured by a chlorine dioxide sensor;
ClO₂ Dynamic is a concentration of ClO₂ being fed to the water from the chlorine dioxide feed system and is based on a total volume of water being treated per unit time (ClO₂ ppm/minute); and
Dynamic Compensation (DC) is a unique value for each aquatic facility and compensates effects of lag-time on measurement of the chlorine dioxide concentration in the water by the chlorine dioxide sensor after chlorine dioxide has been fed to the water from the chlorine dioxide feed system, and the DC has a value ranging from 0.2 to 2.0;
wherein,
the process controller initiating a remediation cycle;
the process controller feeding the chlorine dioxide from the chlorine dioxide feed system to the water during the On-Time;
measuring a chlorine dioxide concentration in the water using the chlorine dioxide sensor; and
the process controller stopping feeding of the chlorine dioxide from the chlorine dioxide feed system to the water when the targeted chlorine dioxide CT Value of the water is obtained.

34. The method in accordance with claim 33, further comprising sensors for measuring ORP, free chlorine, total chlorine, temperature and flow rate of the circulating water.

35. The method in accordance with claim 33, wherein chlorine dioxide feed system for control of chlorine dioxide comprises a chlorine dioxide generator.

36. The method in accordance with claim 33, wherein chlorine dioxide feed system comprises accelerated in-situ generation of chlorine dioxide.

37. The method in accordance with claim 33, wherein the Dynamic Compensation value is 1.0.

38. The method in accordance with claim 33, further comprising optimizing the Dynamic Compensation following the formula:
$$DC ( Optimized Value ) = Theoretical {ClO}_{2} ( ppm ) increase / Deviation from Setpoint ( ppm ) \times Y$$
Where,
$$“ Theoretical {ClO}_{2} ( ppm ) increase ” = ( ON - Time / Time segment ) \times lag - time \times {ClO}_{2}$$
$$“ Deviation from Setpoint ” = {ClO}_{2} Setpoint - Measured {ClO}_{2}$$
“Y” is the “Lag-time Adjustment” having a value ranging from 1.01 to 2.0, preferably 1.05 to 1.8, and most preferred 1.1 to 1.5.

39. The method in accordance with claim 38, wherein the Dynamic Compensation is automatically optimized by the process controller.

40. The method in accordance with claim 38, wherein the Dynamic Compensation is optimized manually.

41. The method in accordance with claim 33, wherein the Recovery Remediation cycle having a completion time interval ranging between 0.25 to 3.5 hours and a ClO₂ Setpoint ranging from 2 to 20 ppm.

42. The method in accordance with claim 41, wherein the ClO₂ Setpoint ranges from 3 to 15 ppm.

43. The method in accordance with claim 42, wherein the ClO₂ Setpoint ranges from 4 to 10 ppm.

44. The method in accordance with claim 33, wherein the Routine Remediation cycle having a completion time interval ranging between 3.5 to 24 hours and a ClO₂ Setpoint ranging from 0.2 to 1.0 ppm.

45. The method in accordance with claim 44, wherein the ClO₂ Setpoint ranges from 0.2 to 0.8 ppm.

46. The method in accordance with claim 45, wherein the ClO₂ Setpoint ranges from 0.3 to 0.6 ppm.

47. The method in accordance with claim 33, wherein the Recovery Remediation further comprises a Biofilm Remediation cycle and a Shock Remediation cycle.

48. The method in accordance with claim 47, wherein the Bio-film Remediation cycle having a chlorine dioxide CT Value ranges from 300 to 3000 (mg/l×min).

49. The method in accordance with claim 48, wherein the chlorine dioxide CT Value ranges from 400 to 2500 (mg/l×min).

50. The method in accordance with claim 49, wherein the chlorine dioxide CT Value ranges from 500 to 2000 (mg/l/min).

51. The method in accordance with claim 47, wherein the Shock Remediation cycle having a chlorine dioxide CT Value ranges from 80 to 400 (mg/l×min).

52. The method in accordance with claim 51, wherein the chlorine dioxide CT Value ranges from 90 to 350 (mg/l×min).

53. The method in accordance with claim 52, wherein the chlorine dioxide CT Value ranges from 100 to 300 (mg/l/min).

54. The method in accordance with claim 33, wherein controlling the Recovery Remediation cycle comprising:
the process controller initiating the Recovery Remediation cycle;
measuring the chlorine dioxide concentration and calculating a chlorine dioxide Ct value;
sustaining the concentration of chlorine dioxide until the targeted chlorine dioxide Ct value is achieved;
and the process controller recordings the time when the targeted chlorine dioxide Ct value is achieved and terminating the remediation cycle.

55. The method in accordance with claim 33, wherein the Routine Remediation cycle further comprises a Daily Remediation cycle and/or Continuous 24/7 Remediation cycles.

56. The method in accordance with claim 55, wherein the Routine Remediation cycle having a chlorine dioxide CT Value ranges from 80 to 400 (mg/l×min).

57. The method in accordance with claim 56, wherein the chlorine dioxide CT Value ranges from 90 to 300 (mg/l×min).

58. The method in accordance with claim 57, wherein the chlorine dioxide CT Value ranges from 100 to 250 (mg/l/min).

59. The method in accordance with claim 55, wherein controlling the Daily Remediation cycles comprising:
the process controller initiating the Daily Remediation cycle;
measuring the chlorine dioxide concentration;
calculating a chlorine dioxide Ct value;
sustaining the concentration of chlorine dioxide until the targeted chlorine dioxide Ct value is achieved;
and the process controller recording the time when the targeted chlorine dioxide Ct value is achieved and terminating the remediation cycle.

60. The method in accordance with claim 55, wherein controlling the Continuous 24/7 Remediation cycles comprising:
the process controller initiating the Continuous 24/7 Remediation cycles;
measuring the chlorine dioxide concentration;
calculating a chlorine dioxide Ct value;
sustaining the concentration of chlorine dioxide until the targeted chlorine dioxide Ct value is achieved,
and wherein the process controller records the time when the targeted chlorine dioxide Ct value is achieved terminating the remediation cycle, resets the chlorine dioxide Ct value to zero, then repeats the process.

61. The method in accordance with claim 33, further comprising setting the chlorine dioxide chemical feed system(s) to their maximum output.

62. The method in accordance with claim 33, further comprising controlling the sanitizer and pH control feed systems using time-based proportional control.

63. The method in accordance with claim 33, wherein the chlorine dioxide Ct value is calculated following the equation:
$$Chlorine dioxide Ct value = [ ( \sum {X}_{n} ) \div n ] \times T$$
Where:
“Xₙ” is the chlorine dioxide concentration in mg/l (or ppm) recorded at a point in time since beginning the remediation cycle.
“n” is the number of chlorine dioxide values recorded over a period of time since beginning the remediation cycle.
“T” is the period of time (minutes) that has lapsed since beginning the remediation cycle.

64. The method in accordance with claim 33, wherein the chlorine dioxide Ct Value is calculated following the equation:
$$Chlorine dioxide Ct value = \sum [ ( \sum {X}_{n} \div n ) \times T ]$$
Where:
“X” is the chlorine dioxide concentration in mg/l (or ppm) recorded at a point in time over the sampling period.
“n” is the number of chlorine dioxide values recorded over the sampling period.
“T” is the period of time (minutes) that has lapsed over the sampling period.

65. The method in accordance with claim 33, further comprising UV activation of chlorite ions to produce chlorine dioxide.

66. The method in accordance with claim 33, further comprising the cyclic process wherein hypobromous acid activates chlorite to produce chlorine dioxide.
